(19) United States
(12) Patent Application Publication
(10) Pub. No.: US 2022/0300394 A1
(43) Pub. Date: Sep. 22, 2022

(54) SYSTEM AND METHOD FOR CONTROLLING DATA FLOW FOR CRYPTOCURRENCY MINING BASED POWER PRICE ANALYSIS

(71) Applicant: Andrew Webber, Elmsford, NY (US)

(72) Inventor: Andrew Webber, Elmsford, NY (US)

(21) Appl. No.: 17/700,020

(22) Filed: Mar. 21, 2022

Related U.S. Application Data
(60) Provisional application No. 63/163,569, filed on Mar. 19, 2021.
(60) Provisional application No. 63/210,982, filed on Jun. 15, 2021.

(51) Int. Cl. G06F 11/34; G06F 1/3209; H04L 67/025

(52) U.S. Cl. CPC G06F 11/3442; G06F 1/3209; H04L 67/025

(57) ABSTRACT

A system and method for controlling data flow and analyzing power price from one or more power plants is disclosed. The system is configured to analyze power price and control data flow to or from one or more power plants in order to determine whether a given mining computer/CPU is processing or not processing based on the power price and data flow from the power plants for cryptocurrency mining. The system further comprises a smart analysis processing system for retrieving power price data from the power plants and also receives coin price data. The system comprises a computing device having a processor(s) and a memory having a software module executed by the processor. The system comprises one or more program modules such as, a learning module, an enumeration module, a REC module, a power cost analysis module, a control module, and an admin module, which are executed by the processor to perform multiple functions.

### RELATED PATENT APPLICATION AND PRIORITY

This application claims priority to: (1) U.S. Provisional Patent Application 63/163,569 filed Mar. 19, 2021; and (2) to U.S. Provisional Patent Application 63/210,982 filed Jun. 15, 2022, both of which is incorporated herein by reference in their entirety.

### BACKGROUND OF THE INVENTION

The present invention generally relates to a system and method for controlling data flow and analyzing power price from one or more power plants or other sources of power (power plants and other sources of power are collectively referred to herein as “power plants”). More specifically, the present invention relates to a system and method for analyzing power price and controlling data flow to or from one or more power plants in order to determine whether a given cryptocurrency machine or mining computer/CPU is processing or not based on the power price, cryptocurrency price, and data flow from the power plants for cryptocurrency mining.

### RELATED APPLICATION

Electrical power generated by power plants is distributed through large networks, such as power grids, that transmit the power from power plant to power consuming customers, such as homes, factories and office buildings. Electrical power distributed by the power grid is typically sold to customers who are connected to the grid. The price for power is often set by the demand for power. The power plants or other sources of power must determine the amount of power to be generated for sale over a power grid. The determination is typically based on the anticipated sales price for power, the anticipated demand for power, the cost to generate and distribute power, and the operating condition of the power plant.

Currently, power plants or other sources of power utilize their excess power for cryptocurrency mining. Cryptocurrency mining is a compelling revenue generating opportunity for the power plants or other sources of power to earn cryptocurrencies, for example, Bitcoin. In order to increase the mining capacity, additional and/or processing modules and cryptocurrency mining machines could be assembled in order to increase the amount of cryptocurrency mined over a period of time. Further, the cryptocurrency mining machines and processing modules should require a control process for activating/processing and deactivating/not-processing based on power price and data flow from the power plants or other sources of power.

However, the additional processing modules and cryptocurrency machines could result in excessive power consumption. Further, existing systems and methods are difficult for the user to determine whether a given cryptocurrency mining machine is processing or not processing based on the power price and data flow.

In light of the above-mentioned problems, it would be highly desirable to provide a system and method for analyzing power price and controlling data flow to or from one or more power plants or other sources of power in order to determine whether a given cryptocurrency machine or mining computer/CPU is processing or not processing based on the power price and data flow from the power plants or other sources of power for cryptocurrency mining.

### SUMMARY OF THE INVENTION

The present invention generally discloses a system and method for controlling data flow and analyzing power price to or from one or more power plants or other sources of power. Further, the present invention discloses a system and method for analyzing power price and controlling data flow to or from one or more power plants or other sources of power in order to determine whether a given cryptocurrency machine or mining computer/CPU is processing or not processing as determined by the power price and data flow from the power plants or other sources of power for cryptocurrency mining.

In one embodiment, the system is configured to analyze power price data from one or more power plants or other sources of power such as a nuclear plant, a coal plant, a wind power station (i.e., wind farm), and/or a photovoltaic power station (i.e., a solar farm). The primary purpose of power plants is to produce power for distribution through the grid, in exchange for payment for the supplied electricity. Each generation station includes power generation equipment capable of supplying utility-scale power. In one embodiment, the power plants may further include station electrical equipment.

In one embodiment, the system further comprises a smart analysis processing system for retrieving power price data from the power plants and also receives cryptocurrency coin price data. In one embodiment, the smart analysis processing system is in communication with one or more data controllers, configured to control the operation of one or more mining computers/CPUs or cryptocurrency machines, which are assembled in one or more racks such as rack 1, rack 2, and rack n, etc. In one embodiment, the system is configured to analyze power price and control data flow to or from one or more power plants in order to determine whether a given cryptocurrency machine or mining computer/CPU is processing or not processing based on the power price and data flow from the power plants for cryptocurrency mining.

In one embodiment, the system comprises a computing device or a control server having a processor(s) and a memory having a software module executed by the processor. In one embodiment, the software module could be a webpage application (web app). In some embodiments, the software module could be at least one of, but not limited to, a plug-in component and/or a browser extension. In one embodiment, the processor is in communication with a server via a network. In one embodiment, the system further comprises a graphics processing and a communication interface. In one embodiment, the system further comprises a database in communication with the server which is configured to store data related to power price and coin price. The database comprises one or more program modules such as, a learning module, an enumeration module, a REC module, a power cost analysis module, a control module, and an admin module. In one embodiment, the program modules are executed by the processor to perform multiple functions.

In one embodiment, the processor, memory, graphics processing, and the communication interface could be connected via a communication bus or one or more connection mechanisms (e.g., a connection mechanism). In this disclosure, the term “connection mechanism” means a mechanism that facilitates communication between two or more devices, systems, components, or other entities.

In one embodiment, the computing device of the system is in communication with the virtual cryptocurrency coin pricing data, virtual cryptocurrency coin data processing, and the power price/cost data. In one embodiment, the computing device of the system is in communication with one or more mining computers/CPUs.

In one embodiment, the computing device is at least any one of, but not limited to, a smartphone, a laptop, a computer, a tablet, a mobile phone, or other suitable mobile and/or electronic devices, and also virtual machines on cloud servers. In one embodiment, the network could be, but not limited to, a blockchain network, a private blockchain network based on Hyperledger, and Ethereum. In one embodiment, the system could be a platform or a browser extension, which is installed in the computing device, which is wired or wirelessly connected to the network. In one embodiment, the browser extension could be stored in an internal or external database, which is in communication with the server. In one embodiment, the computing device is enabled to access the server via the network. In one embodiment, the computing device is in communication with the server, wherein such communication is established via a software application, a browser extension, a mobile application, a browser, an OS, and/or any combination thereof. In some embodiments, the computing device could be, but not limited to, a touch screen and/or a non-touchscreen and adapted to run on any type of OS, such as iOS™, Windows™ Android™, Unix™, Linux™ and/or others.

In on embodiment, the present invention provides a flexible datacenter comprising a plurality of computing systems, where the plurality of computing systems are configured to receive power from at least one power source, where the plurality of computing systems are in a low power sleep mode when not receiving data; and a data control system configured to control data flow to the plurality of computing systems based at least in part on a change in economic feasibility. Where the plurality of computing systems process data when data is transmitted by the data control system. Further, wherein the change in economic feasibility comprises the cost of power to power the plurality of computing systems of the flexible datacenter. Further, the data control system controls the transmission of data to one or more computing systems of the plurality of computing systems or controls the transmission of data to a select group of computing systems of the plurality of computing systems. The data control system is also configured to determine the change in economic feasibility. Alternatively, the change in economic feasibility is communicated to the data control system by an operator associated with the flexible datacenter or by a remote master control system. The data control system may be collocated with the plurality of computing systems or located remotely from the plurality of computing systems. Further, wherein the change in economic feasibility is based on the cost of power to power the plurality of computing systems of the flexible datacenter compared to the price of a crypto coin. The data control system may be comprised of at least one primary controller and at least one lead controller. The data control system may be comprised of at least one firewall, at least one monitoring server, and at least one switch. The data control system may be comprised of at least one firewall, at least one monitoring server, at least one lead switch and at least one rack switch.

The present invention also provides a method of controlling a flexible datacenter comprising: receiving, by a data control system processor, a request for an application to be executed by the data control system processor, wherein the application includes a plurality of tasks including an economic feasibility analysis, a crypto mining machine analysis, and a data control schema analysis; analyzing, by the data control system processor, the economic feasibility analysis by comparing a cost of power and the price of a crypto coin; determining, by the data control system processor, a crypto coin processing condition has been met based on the economic feasibility analysis; analyzing, by the data control system processor, the crypto mining machine analysis by comparing a plurality of performance capabilities of a plurality of crypto mining computing systems within the flexible datacenter to determine a set of selected crypto mining computing machines from the plurality of crypto mining computing machines which should mine crypto coin based on the economic feasibility analysis; analyzing, by the data control system processor, the data control schema analysis by identifying a set of data flow parameters required to transmit a set of crypto mining data to be transmitted to the set of selected crypto mining machines; and controlling at least one firewall and at least one switch using the set of data flow parameters to control the transmission of the set of crypto mining data to the set of selected crypto mining machines. The method may further comprise halting the flow of the set of crypto mining data to the set of selected crypto mining machines when the crypto coin processing condition is no longer met. The method of controlling data may be implemented through at least one switch which may be comprised of at least one lead switch and at least one rack switch. The method of controlling data may be implemented through at least one firewall comprises at least one lead firewall and at least one rack firewall. The method may further comprise a crypto mining machine device analysis comprising conducting a scan of the plurality of crypto mining devices within the flexible datacenter to determine the plurality of performance capabilities of each mining device of the a plurality of crypto mining computing systems. The method may further comprise grouping the plurality of crypto mining devices within the flexible datacenter based on the plurality of performance capabilities of each mining device.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The embodiments herein will be better understood from the following detailed description with reference to the drawings, in which:

FIG. 1 exemplarily illustrates a block diagram of a system for controlling data flow and analyzing power price from one or more power plants, according to an embodiment of the present invention.

FIG. 2 exemplarily illustrates a block diagram of a computing device of the system, according to one embodiment of the present invention.

FIG. 3 exemplarily illustrates a block diagram of a one or more computer racks and a plurality of mining computers/CPUs provided in the computer racks, according to one embodiment of the present invention.

FIG. 4 exemplarily illustrates a block diagram of a complete rack provided with different types of mining computers/CPUs, according to one embodiment of the present invention.

FIG. 5 exemplarily illustrates a block diagram of a complete rack provided with different types of mining computers/CPUs, where the mining computers/CPUs are organized and enumerated or identified with numbers, according to one embodiment of the present invention.

FIG. 6 exemplarily illustrates a block diagram of a complete rack provided with different types of mining computers/CPUs, where the mining computers/CPUs are not organized but are enumerated or identified with numbers, according to one embodiment of the present invention.

FIG. 7 exemplarily illustrates a block diagram of the system 100 configured to control data (to mine) flow to the mining computers/CPUs (by group), which are assembled in a rack through various controllers, according to one embodiment of the present invention.

FIG. 8 exemplarily illustrates a block diagram of the system configured to control data (to mine) flow to the mining computers/CPUs (by group), which are assembled in more racks through various controllers, according to one embodiment of the present invention.

FIG. 9A exemplarily illustrates a block diagram of the system 100 configured to control data (to mine) flow to the mining computers/CPUs (by group), which are assembled in a rack through use of a monitoring server, firewall, and various switches, according to one embodiment of the present invention.

FIG. 9B exemplarily illustrates a block diagram of the system configured to control data (to mine) flow to the mining computers/CPUs (by group), which are assembled in more racks through use of a monitoring server, firewall, and various switches, according to one embodiment of the present invention.

FIG. 10 exemplarily illustrates a flowchart of a method for controlling or permitting data flow to selected mining computers/CPUs for distribution of power window, according to one embodiment of the present invention.

FIG. 11 exemplarily illustrates a flowchart of a method for enumerating/identifying the plurality of mining computers/CPUs, according to one embodiment of the present invention.

FIG. 12 exemplarily illustrates a flowchart of a method for transmitting data to finalized groups/mining computers/CPUs through various controllers for mining cryptocurrency, according to one embodiment of the present invention.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

Embodiments of the present disclosure will be illustrated below in conjunction with the various figures.

The term “module” as used herein refers to any known or later developed hardware, software, firmware, artificial intelligence, fuzzy logic, or combination of hardware and software that is capable of performing the functionality associated with that element. Also, while the present disclosure is described in terms of exemplary embodiments, it should be appreciated that those individual aspects of the present disclosure can be separately claimed.

The term “computer-readable medium” as used herein refers to any tangible storage and/or transmission medium that participates in storing and/or providing instructions to a processor for execution. Such a medium may take many forms, including but not limited to, nonvolatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attached to email or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Further, while reference is made to various types of databases, it will be understood by one of ordinary skill in the art that all of the database functions may be stored within compartments of a single database, or within individual databases. In any event, the disclosure is considered to include a tangible storage medium or distribution medium and prior art-recognized equivalents and successor media, in which the software implementations of the present disclosure are stored.

Various embodiments of the present disclosure are described with reference to the accompanying drawings. Accordingly, those of ordinary skill in the art will recognize that a modification, an equivalent, and/or an alternative on the various embodiments described herein may be variously made without departing from the scope and spirit of the present disclosure. With regard to the description of the accompanying drawings, similar elements may be marked by similar reference numerals.

In the present disclosure, the expressions “have”, “may have”, “include”, “comprise”, “may include”, and “may comprise” used herein indicate the existence of corresponding features (e.g., elements such as numeric values, functions, operations, or components) but do not exclude the presence of additional features.

In the present disclosure, the expressions “A or B”, “at least one of A and/or B”, “one or more of A and/or B”, and the like used herein may include any and all combinations of one or more of the associated listed items. For example, the expressions “A or B”, “at least one of A and B”, and “at least one of A or B” may refer to all of a case (1) where at least one A is included, a case (2) where at least one B is included, and a case (3) where both of at least one A and at least one B are included.

The terms “first”, “second”, and the like used herein may refer to various elements of various embodiments, but are not intended to limit the elements. Furthermore, such terms may be used to distinguish one element from another element. For example, “a first user device” and “a second user device” may indicate different user devices regardless of the order or priority thereof. For example, “a first user device” and “a second user device” indicate different user devices.

It is intended that when an element (e.g., a first element) is referred to as being “(operatively or communicatively) coupled with/to” or “connected to” another element (e.g., a second element), the element may be directly coupled with/to or connected to the other element or an intervening element (e.g., a third element) may be present. In contrast, when an element (e.g., a first element) is referred to as being “directly coupled with/to” or “directly connected to” another element (e.g., a second element), it is intended that there are no intervening element (e.g., a third element).

According to the situation, the expression “configured to” may be interchangeably used with the expressions “suitable for”, “having the capacity to”, “designed to”, “adapted to”, “made to”, or “capable of”. The term “configured to” may not indicate only “specifically designed to” in hardware. Instead, the expression “a device configured to” may indicate that the device is “capable of” operating together with another device or other components. A central processing unit (CPU), for example, a “processor configured to perform A, B, and C”, may indicate a dedicated processor (e.g., an embedded processor) for performing a corresponding operation or a general-purpose processor or portion of a processor (e.g., a CPU or an application processor (AP)) which may perform corresponding operations by executing one or more software programs which are stored in a memory device.

Terms used in the present disclosure are used to describe certain embodiments but are not intended to limit the scope of the present disclosure. A term of a singular form may include a plural form unless otherwise indicated. Unless otherwise defined herein, all the terms used herein, may have the same meanings that are generally understood by a person skilled in the art. It may be further understood that terms, which are defined in a dictionary and commonly used, should also be interpreted as is customary in the relevant related art and not in an idealized or overly formal manner unless expressly so defined herein in various embodiments of the present disclosure. In some cases, even if terms are defined in the present disclosure, they are not intended to be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), moving picture experts group (MPEG-1 or MPEG-2), audio layer 3 (MP3) players, mobile medical devices, cameras, wearable devices (e.g., head-mounted-devices (HMDs), such as electronic glasses), an electronic apparel, electronic bracelets, electronic necklaces, electronic accessories, electronic tattoos, smart watches, and the like.

Hereinafter, an electronic device according to the various embodiments of the present disclosure may be described with reference to the accompanying drawings. The term “user” used herein may refer to a person who uses an electronic device or may refer to a device (e.g., an artificial intelligence electronic device) that uses an electronic device.

“Electrical grid” or “grid,” as used herein, refers to a Wide Area Synchronous Grid (also known as an Interconnection), and is a regional scale or greater electric power grid which operates at a synchronized frequency and is electrically tied together during normal system conditions. An electrical grid delivers electricity from generation stations to consumers. An electrical grid includes: (i) generation stations that produce electrical power at large scales for delivery through the grid, (ii) high voltage transmission lines that carry that power from the generation stations to demand centers, and (iii) distribution networks which carry that power to individual customers.

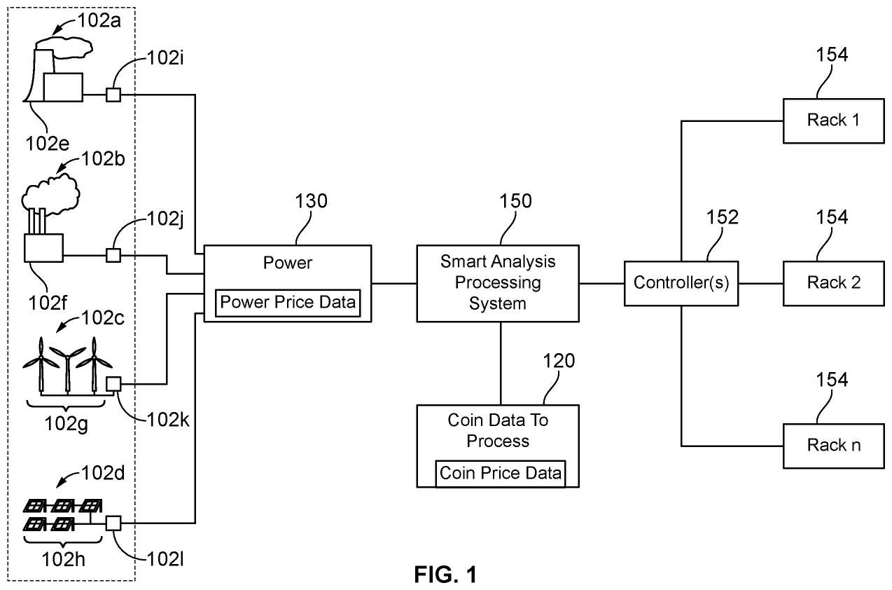

Referring to FIG. 1, a system 100 for analyzing power price and controlling data flow to or from one or more power plants to cryptocurrency machines in one embodiment is disclosed. The system 100 could be incorporated as a computer-readable medium, or as a computing system. In an example, a system 100 includes a set of computing systems. The set of computing systems is configured to perform computational operations using power from any power plant or source. The system 100 also includes a control system configured to monitor a set of conditions and control various processing steps while monitoring the set of conditions. Said system 100 is configured to control data flow (firewalls, queue servers, wake on LAN, etc.) to specific types of computers or electronic devices. In one embodiment, the system 100 is configured to analyze power price data from one or more power plants such as a nuclear plant 102a, a coal plant 102b, a wind power station (i.e., wind farm) 102c, and/or a photovoltaic power station (i.e., a solar farm) 102d. The primary purpose of power plants is to produce power for distribution through the grid, and in exchange for payment for the supplied electricity. Each of the generation stations 102a-d includes power generation equipment 102e-h, respectively, typically capable of supplying utility-scale power. In one embodiment, the power plants 102a-d may further include station electrical equipment 102i-1, respectively.

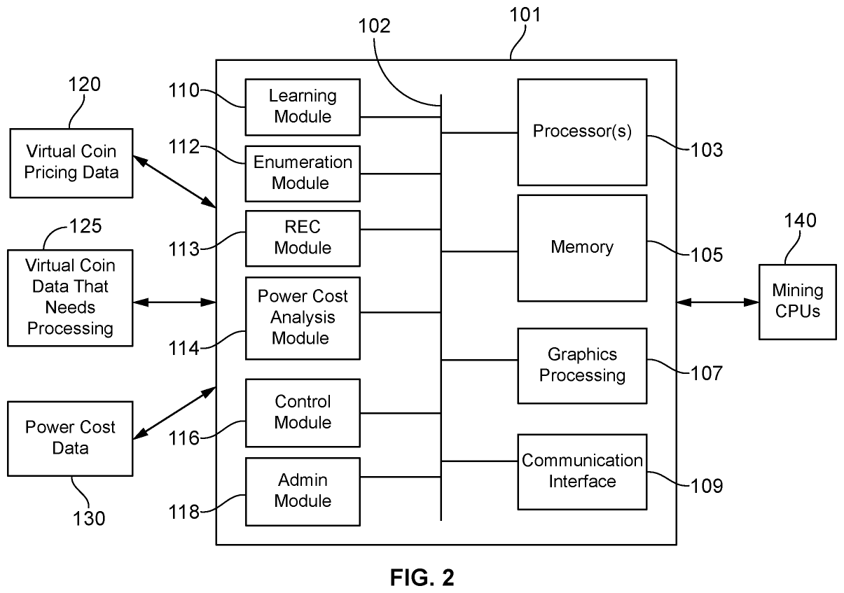

In one embodiment, the system 100 further comprises a smart analysis processing system 150 for retrieving power price data 130 from the power plants 102a-d and also receive coin price data 120. In one embodiment, the smart analysis processing system 150 is in communication with one or more controllers 152, configured to control the operation of one or more mining computers/CPUs or cryptocurrency machines 140 (shown in FIG. 2), which are assembled in one or more racks such as rack 1, rack 2, and rack n, etc. In one embodiment, the system is configured to analyze power price and control data flow to or from one or more power plants 102a-d in order to determine whether which cryptocurrency machine or mining computer/CPU 140 is processing or not based on the power price and data flow from the power plants for cryptocurrency mining.

Referring to FIG. 2, a block diagram of a computing device 101 of the system 100 in one embodiment is disclosed. In one embodiment, the system 100 comprises a computing device or a control server 101 having a processor(s) 103 and a memory 106 having a software module executed by the processor 103. In one embodiment, the software module could be a webpage application (web app). In some embodiments, the software module could be at least one of, but not limited to, a plug-in component and/or a browser extension. In one embodiment, the processor 103 is in communication with a server via a network. In one embodiment, the system 100 further comprises a graphics processing 107 and a communication interface 109. In one embodiment, the system 100 further comprises a database in communication with the server which is configured to store data related to power price and coin price. The database comprises one or more program modules such as, a learning module 110, an enumeration module 112, a REC module 113, a power cost analysis module 114, a control module 116, and an admin module 118. In one embodiment, the program modules are executed by the processor 103 to perform multiple functions.

In one embodiment, the processor 103, memory 105, graphics processing 107, and the communication interface 109 could be connected via a communication bus 102 or one or more connection mechanisms (e.g., a connection mechanism). In this disclosure, the term “connection mechanism” means a mechanism that facilitates communication between two or more devices, systems, components, or other entities.

In one embodiment, the computing device 101 of the system 100 is in communication with external data on cryptocurrency pricing data 120, virtual coin data processing 125, and the power price/cost data 130. In one embodiment, the computing device 101 of the system 100 is in communication with one or more mining computers/CPUs 140.

In one embodiment, the computing device 101 is at least any one of, but not limited to, a smartphone, a laptop, a computer, a tablet, a mobile phone, or other suitable mobile and/or electronic devices, and also virtual machines on cloud servers. In one embodiment, the network could be, but not limited to, a blockchain network, a private blockchain network based on Hyperledger, and/or Ethereum. In one embodiment, the system 100 could be a platform or a browser extension, which is installed in the computing device 101, which is wired or wirelessly connected to the network. In one embodiment, the browser extension could be stored in an internal or external database, which is in communication with the server. In one embodiment, the computing device 101 is enabled to access the server via the network. In one embodiment, the computing device 101 is in communication with the server, wherein such communication is established via a software application, a browser extension, a mobile application, a browser, an OS, and/or any combination thereof. In some embodiments, the computing device 101 could be, but not limited to, a touch screen and/or a non-touchscreen and adapted to run on any type of OS, such as iOS™, Windows™, Android™, Unix™, Linux™ and/or others.

In one embodiment, the enumeration module 112 comprises a logic, at least partially comprising hardware logic, executable at a networked device. The logic may be configured to enumerate resources of the networked device without dependency on write permissions to a file system of the networked device. The logic may also be configured to generate a data object stored in a memory unit of the networked device based on the enumerated resources. In one embodiment, the enumeration module 112 may generate a data object in-memory. The data object may be compressed and encrypted for durable transport across networks including non-secure network paths. For example, the compressed and encrypted data object may be durable such that transport across non-secure network paths may be used when other paths are not available with a reduced risk of exposing private or confidential enumeration detail. The enumeration module 112 is configured to enumerate resources of the networked device without dependency on write permissions to a file system of the networked device, and generate a data object stored in a memory unit of the networked device based on the enumerated resources. In other words, the enumeration module may be configured to generate the data object without write access to a file system of the computing device. In some cases, the enumeration module 112 may be implemented without write access, and may be configured to provide only one-way communication over the network to a central data center wherein the compressed and encrypted data object may be decrypted, decompressed, and analyzed as discussed in more detail below. Being configured to have only one-way access to the central data center may reduce any back-door security threat potential that may otherwise enable malicious or even unintended access to the enumeration module. Further, in some cases, enumeration provided by the enumeration module 112 may be throttled. For example, depending on a given application being run on the computing device, the enumeration module may delay enumeration of resources over a period of time such that performance of any other operation or application may not be influenced. In other words, the enumeration module may be configured to be undetectable in regards to performance degradation that may be caused by an increased load related to enumeration operations.

In one embodiment, the enumeration module 112 may be configured to generate a data object stored in a memory unit, such as the memory unit, of the computing device based on the enumerated resources. The enumerated resources may include any number of resource variations. For example, the enumeration module may be configured to identify, inventory, gather, or otherwise determine installed software packages, hardware components, licenses associated with installed software, updates to hardware components, and the like.

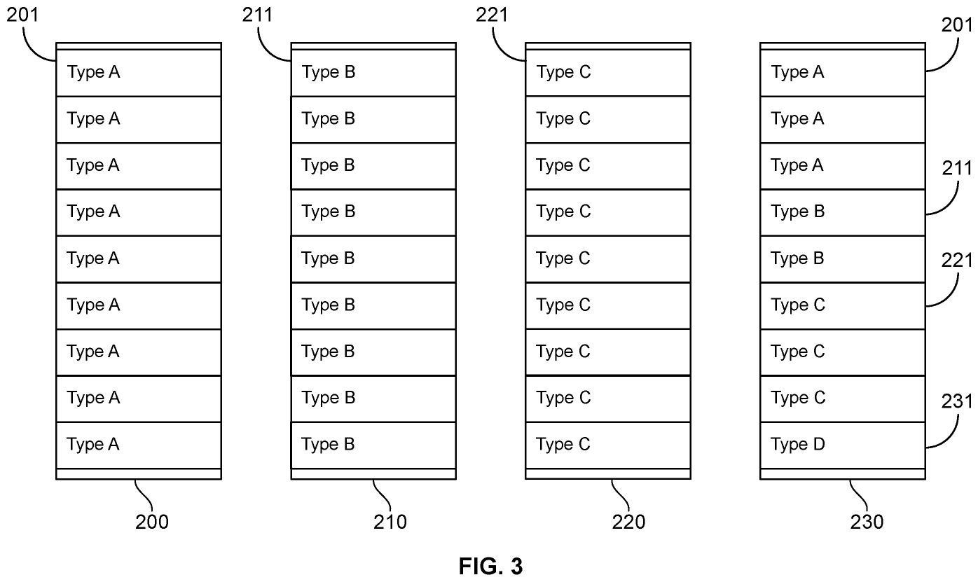

Referring to FIG. 3, one or more computer racks (200, 210, 220, and 230) and a plurality of mining computers/CPUs provided in the computer racks (200, 210, 220, and 230) is disclosed. In one embodiment, the plurality of mining computers/CPUs is assembled in the computer racks (200, 210, 220, and 230). In one embodiment, the plurality of mining computers/CPUs is divided into different types such as type A 201, type B 211, type C 221, and type D 231. In one embodiment, the mining computers/CPUs are assembled in different ways such as type A 201 are in a separate row, type B 211 are in another row, type C 221 are in another row, and all type A, B, C, and D mining computers/CPUs are in a single/unorganized row, etc.

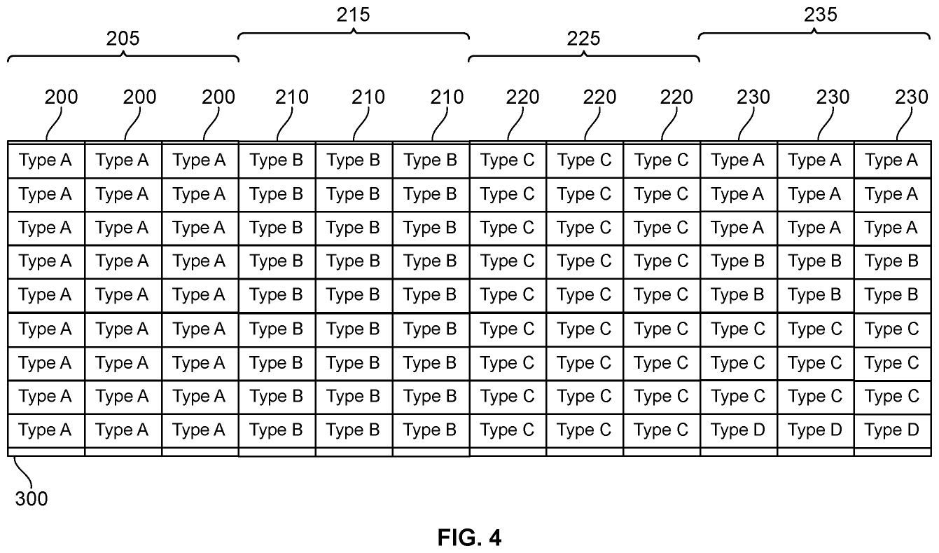

Referring to FIG. 4, a complete rack 300 provided with different types of mining computers/CPUs in one embodiment is disclosed. In one embodiment, the different types of mining computers/CPUs such as type A, B, C, and D could be arranged in an organized manner and an unorganized manner within the rack 300. In one embodiment, the type A mining computers/CPUs are arranged in an organized manner in a section 205 within the rows 200. In one embodiment, the type B mining computers/CPUs are arranged in an organized manner in a section 215 within the rows 210. In one embodiment, the type C mining computers/CPUs are arranged in an organized manner in a section 225 within the rows 220. In one embodiment, the different types of mining computers/CPUs such as type A, B, C, and D could be arranged in an unorganized manner in a section 235 within the rows 230.

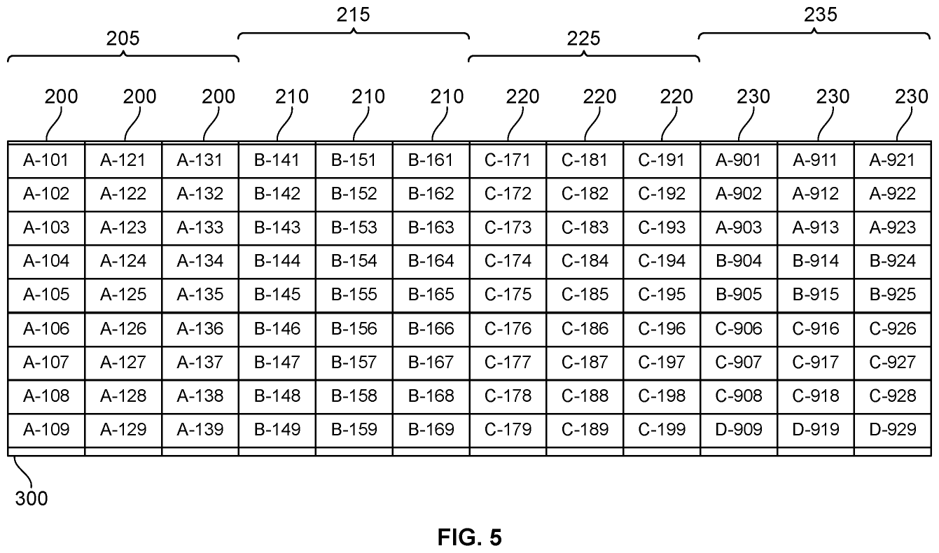

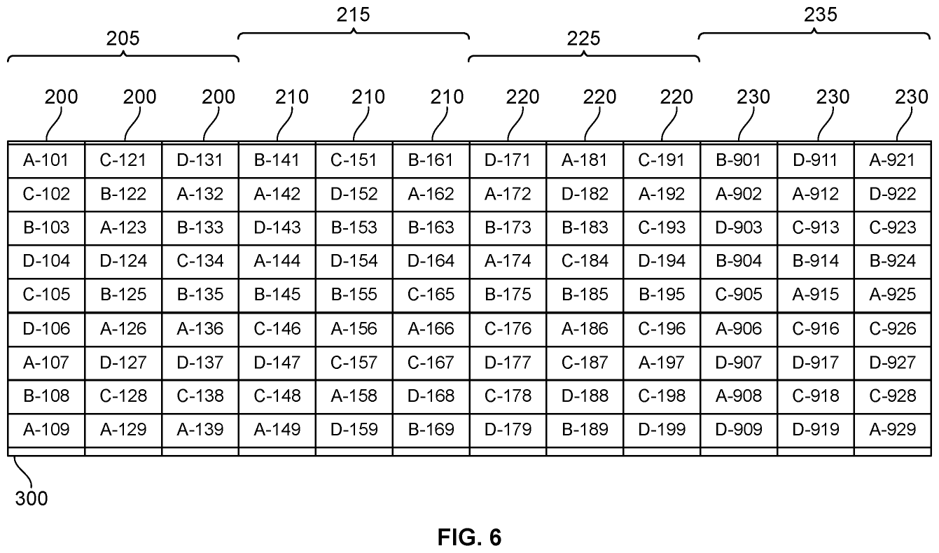

Referring to FIGS. 5-6, a complete rack 300 provided with different types of mining computers/CPUs, where the mining computers/CPUs are enumerated or identified with numbers in one embodiment is disclosed. In one embodiment, the mining computers/CPUs in the rack 300 could be enumerated or identified with numbers, names, letters, and any configuration of names, etc. The mining computers/CPUs are assembled in the rack 300 in an organized manner due to enumeration.

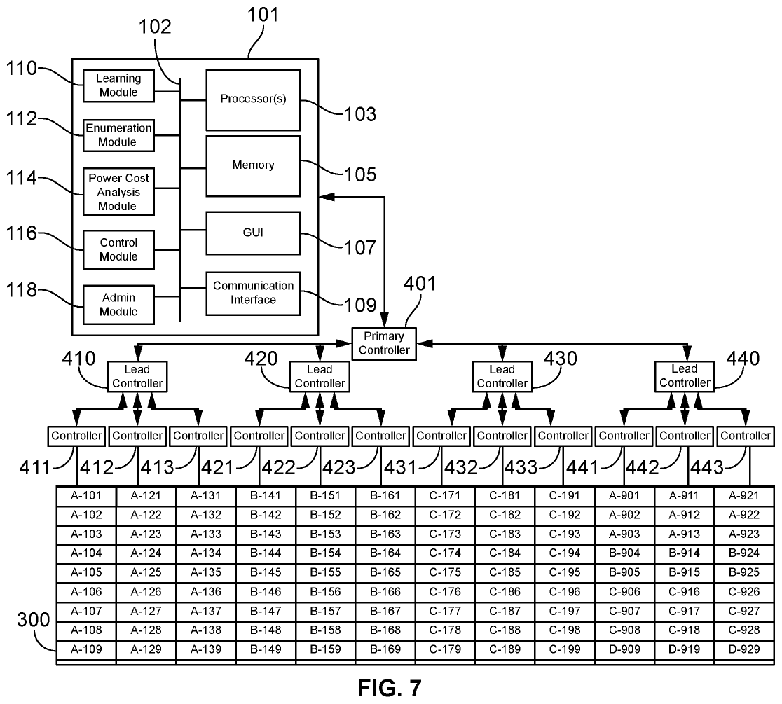

Referring to FIG. 7, a block diagram of the system 100 configured to control data (to mine) flow to the mining computers/CPUs (by group), which are assembled in a rack 300 through various controllers in one embodiment is disclosed. In one embodiment, the computing device 101 of the system 100 is configured to communicate with the mining computers/CPUs through one or more controllers such as a primary controller 401, lead controllers (410, 420, 430, and 440), and rack controllers (411 to 413) (421 to 423) (431 to 433) and (441 to 443) for controlling data (to mine) flow to the mining computers/CPUs (by group).

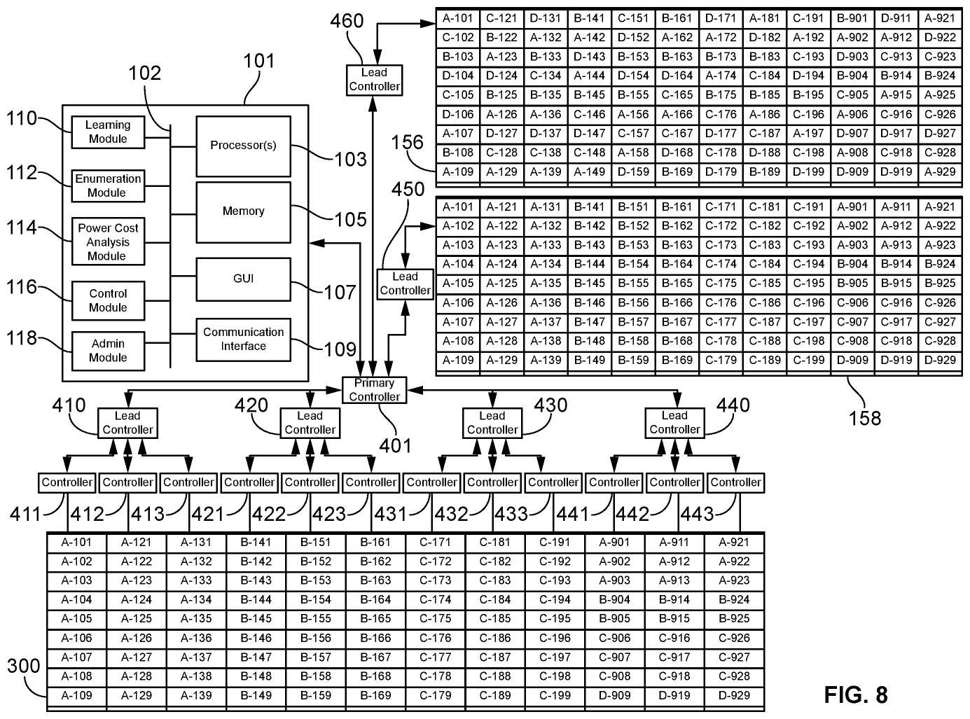

Referring to FIG. 8, a block diagram of the system 100 configured to control data (to mine) flow to the mining computers/CPUs (by group), which are assembled in more racks 156, 158, and 300 through various controllers in one embodiment is disclosed. In one embodiment, the system 100 is configured to communicate with the mining computers/CPUs through one or more controllers such as a primary controller 401, lead controllers, and rack controllers for controlling data (to mine) flow to the mining computers/CPUs, which are assembled in more racks 156, 158, and 300.

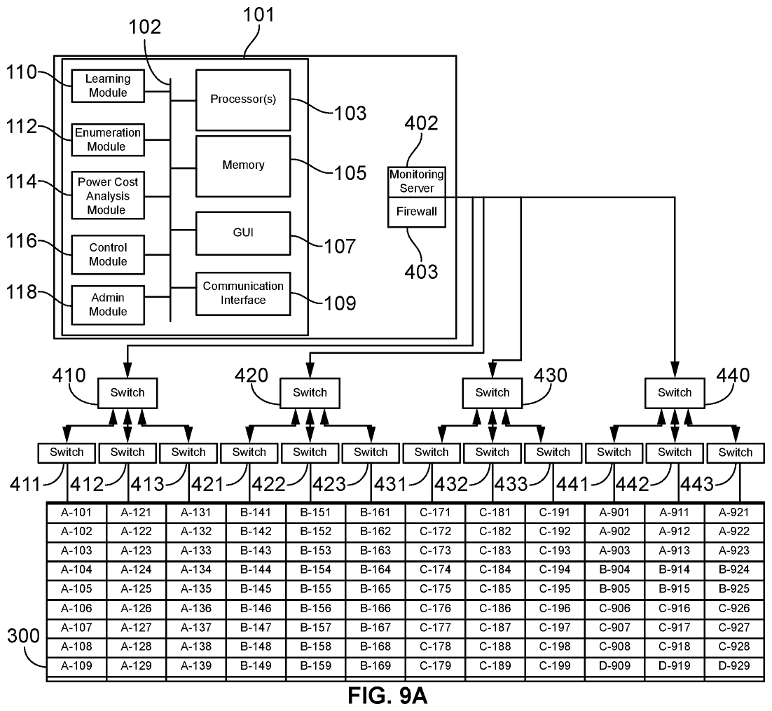

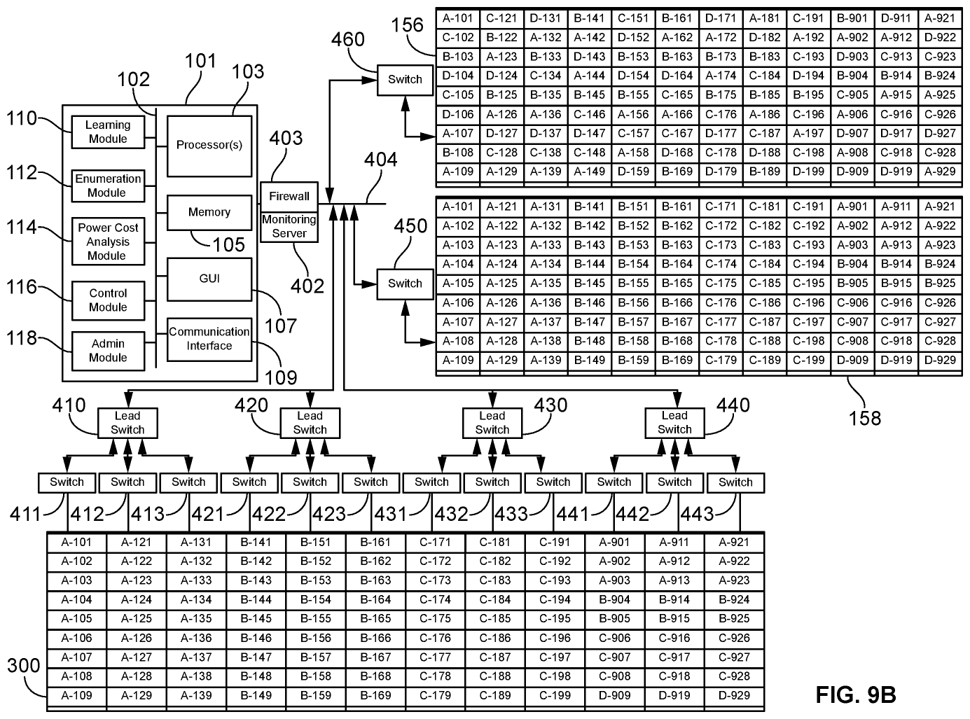

Referring to FIG. 9A, a block diagram of the system 100 configured to control data (to mine) flow to the mining computers/CPUs (by group), which are assembled in a rack 300 through use of a monitoring server 402, a firewall 403, and various switches 410, 420, 430, and 440, according to one embodiment of the present invention. In addition, the various primary switches 410, 420, 430, and 440 are connected to numerous secondary switches. Switch 410 is connected to and controls data to various secondary switches 411, 412, and 413. Switch 420 is connected to and controls data to various secondary switches 421, 422, and 423. Switch 430 is connected to and controls data to various secondary switches 431, 432, and 433. Switch 440 is connected to and controls data to various secondary switches 441, 442, and 443.

The monitoring server 402 is used to monitor the processing and usage of the numerous mining processors in the rack 300. The monitoring server 402 communicates with the control module 116 to balance processing between the various mining servers in the rack 300. Through the power cost analysis module 114 and control module 116, the control computer 101 determines which of the various mining processors in the rack 300 should receive data to mine or process. The control computer 101 controls the firewall 403 and the switches 410-443 to establish which mining processors in the rack 300 receive data to mine. The switches 410-443 are capable of forwarding packets of data based on mining processor information such as the media access control (MAC) address or port information. Specifically, the control computer 101 determines which processors should be used to mine and communicates with the switches 410-443 to provide information on the selected mining devices, based on physical location or IP address. In a preferred embodiment, control computer 101 continuously polls the switches 410-433 and/or the switches 410-433 routinely ping the control computer 101 via http requests. The http information provides information on which ports of each switch 410-433 should be open or closed for data mining. As previously described, the computing system 101 may use the enumerated naming to translate the system enumeration into the MAC address or port information.

Through use of the control computer 101, the system 100 is able to control data flow through the firewall 403 and switches 410-433 to send data to mine to the specific type of mining processor needed based on the power cost analysis and the specific mining units in the rack 300 based on how many mining processors of each type are needed and balanced processing, based on the control module.

FIG. 9B exemplarily illustrates a block diagram of the system 100 configured to control data (to mine) flow to the mining computers/CPUs (by group) in various rack 156, 158, 300 through use of a monitoring server 402, firewall 403, and various lead switches 410, 420, 430, 440, 450, and 460, according to one embodiment of the present invention. In addition, the various primary switches 410, 420, 430, 440, 450, 460 are connected to numerous secondary switches. Switch 410 is connected to and controls data to various secondary switches 411, 412, and 413. Switch 420 is connected to and controls data to various secondary switches 421, 422, and 423. Switch 430 is connected to and controls data to various secondary switches 431, 432, and 433. Switch 440 is connected to and controls data to various secondary switches 441, 442, and 443.

As previously described with reference to FIG. 9A, the monitoring server 402 is used to monitor the processing and usage of the numerous mining processors in the rack 300. The monitoring server 402 communicates with the control module 116 to balance processing between the various mining servers in the rack 300. Through the power cost analysis module 114 and control module 116, the control computer 101 determines which of the various mining processors in the various racks 156, 158, 300 should receive data to mine or process. The control computer 101 controls the firewall 403 and the lead switches and secondary switches 410-460 to establish which mining processors in the racks 156, 158, 300 receive data to mine. As previously described, the control computer 101 continuously polls the switches 410-460 and/or the switches 410-460 routinely ping the control computer 101 via http requests. The http information provides information on which ports of each switch 410-433 should be open or closed for data mining. The switches 410-460 are capable of forwarding packets of data to the appropriate mining processors through the switches 410-460 controlled by the control computer 101.

Through use of the control computer 101, the system 100 is able to control data flow through the firewall 403 and switches 410-460 to send data to mine to one or more racks 156, 158, 300, the specific type of mining processor needed based on the power cost analysis and the specific mining units in the rack 300 based on how many mining processors of each type are needed and balanced processing, based on the control module. The system of the present invention includes one or more high speed data links or data bridges between the control computer 101 and the racks 156, 158, 300. The control computer 101, firewall 403, and switches 410-460 act as a switching manager of data to create temporary connections between the individual mining processing units and the data which needs to be processed or mined.

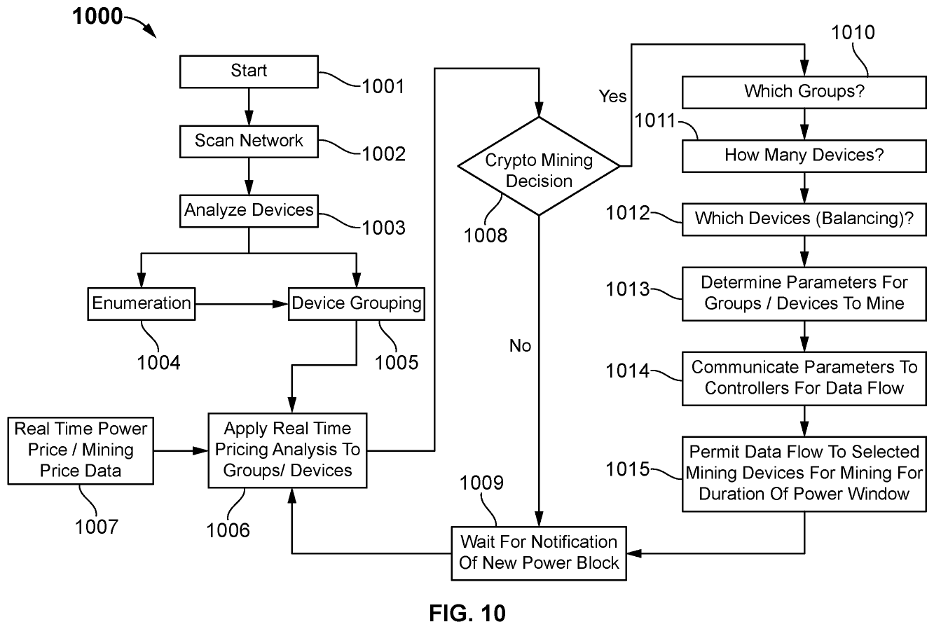

Referring to FIG. 10, a flowchart 1000 of a method for controlling or permitting data flow to selected mining computers/CPUs for distribution of power window is disclosed. At step 1001, the process for controlling or permitting data flow for controlling or permitting data flow is started. At steps 1002 and 1003, a network could be scanned and the mining computers/CPUs could be analyzed. At steps 1002 and 1003, the mining computers/CPUs could be enumerated and separated or divided into multiple groups. At step 1006, the real time pricing analysis could be applied to the mining computers/CPUs or multiple groups. At step 1007, the real time power price or mining price data could be applied to the mining computers/CPUs or multiple groups. At step 1008, a cryptocurrency mining decision will be taken. If the cryptocurrency mining decision is “no” then the mining computers/CPUs go into sleep mode until a notification of a new power block is generated or received. If the cryptocurrency mining decision is yes” then the data flow is permitted to the selected mining computers/CPUs for distribution for the duration of the power window or block through different steps. At steps 1010 to 1012, the mining computers/CPUs are selected by checking groups, number of mining computers/CPUs, which devices (balancing). At step 1013, the parameters are determined for the mining computers/CPUs for mining cryptocurrency. At step 1014, the parameters are communicated to controllers for data flow. Further, at step 1015, data flow is then permitted to the selected mining computers/CPUs for mining for duration of power window.

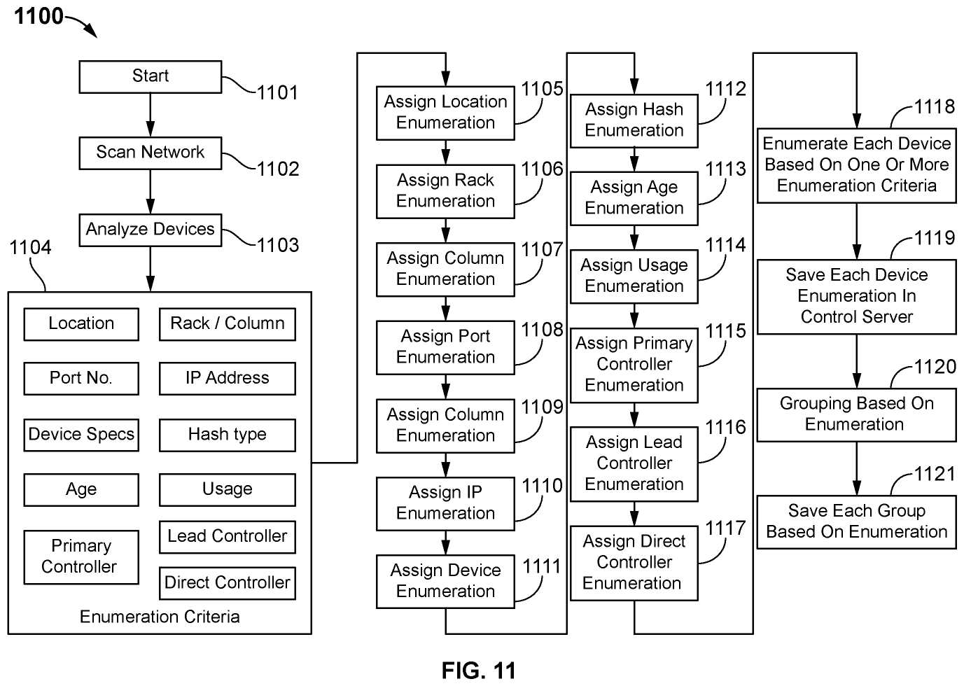

Referring to FIG. 11, a flowchart 1100 of a method for enumerating/identifying the plurality of mining computers/CPUs in one embodiment is disclosed. At step 1101, the process for enumerating/identifying the plurality of mining computers/CPUs is started. At steps 1102 and 1103, a network could be scanned and the mining computers/CPUs could be analyzed. At step 1104, an enumeration criterion could be applied wherein the enumeration criteria comprises different categories such as location, rack/column, port number, IP address, device specs, hash type, age, usage, primary controller, lead controller, and a direct controller. At steps 1105 to 1117, the mining computers/CPUs could be assigned with location enumeration, rack/column enumeration, port enumeration, IP address enumeration, device specs enumeration, hash type enumeration, age enumeration, usage enumeration, primary controller enumeration, lead controller enumeration, and a direct controller enumeration. At step 1118, each mining computer/CPU enumerate based on one or more enumeration criteria. At step 1119, each mining computer/CPU enumeration could be saved in the control server. At step 1120, the mining computers/CPUs could be grouped based on enumeration. Further, at step 1121, the grouped mining computers/CPUs could be saved based on enumeration.

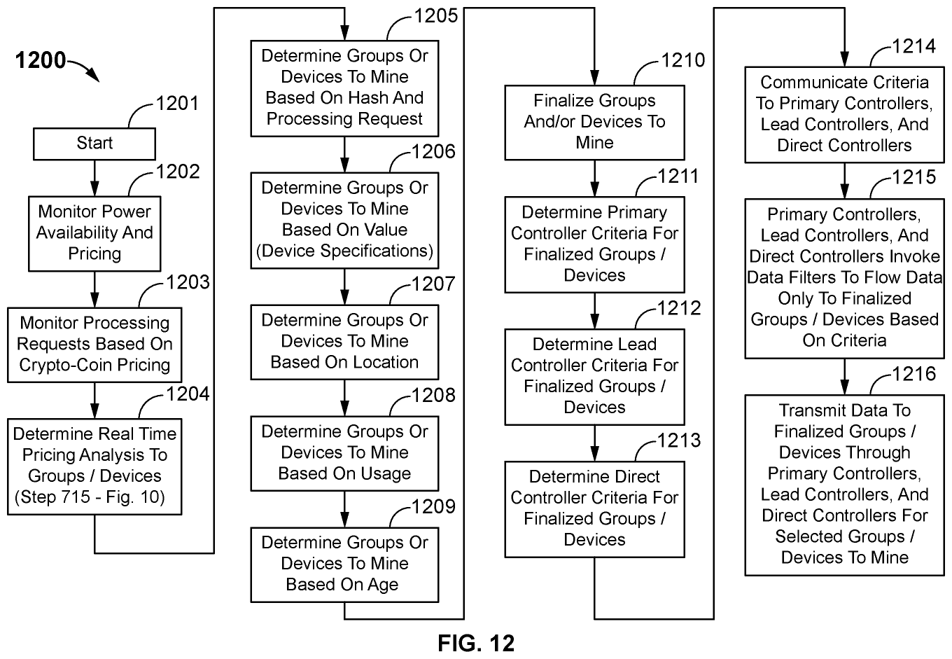

Referring to FIG. 12, a flowchart 1200 of a method for transmitting data to finalized groups/mining computers/CPUs through various controllers for mining cryptocurrency in one embodiment is disclosed. At step 1201, the process for transmitting data to the finalized groups/mining computers/CPUs through various controllers for mining cryptocurrency is started. At step 1202, the power availability and pricing data could be monitored. At step 1203, the processing requests could be monitored based on cryptocurrency coin pricing. At step 1204, the real time pricing analysis could be determined for the mining computers/CPUs. At steps 1205 to 1209, the mining computers/CPUs could be determined for mining cryptocurrency based on hash and processing request, value (device specifications), location, usage, and age. At step 1210, the groups/mining computers/CPUs could be finalized. At step 1211, the primary controller criteria could be determined for finalized groups/mining computers/CPUs. At step 1212, the lead controller criteria could be determined for finalized groups/mining computers/CPUs. At step 1213, the direct controller criteria could be determined for finalized groups/mining computers/CPUs. At step 1214, the system communicates or transmits the criteria to the primary controllers, lead controllers, and the direct controllers. At step 1215, the primary controllers, lead controllers, and the direct controllers invoke data filters to flow data only to the finalized groups/devices based on the criteria. At step 1216, data could be transmitted to the finalized groups/mining computers/CPUs through primary controllers, lead controllers, and the direct controllers for the selected groups/mining computers/CPUs for mining cryptocurrency.

In one embodiment, the system 100 could use secure hash algorithms such as SHA-0, SHA-1, SHA-2, and SHA-256 (most common in the blockchain space and what most coins use including Bitcoin, Bitcoin Cash, and Bitcoin SV), and also SHA-512 (a more complex version of SHA-256 with greater theoretical security and ability to withstand brute force attacks), SHA-3, SHA3-256, SHA3-512, and thereof. In one embodiment, the system 100 could use MD5 which is a less complex security algorithm in 128-bits of one-way mathematical function.

In one embodiment, one or more of the mining computers/CPUs have a different hash rate (measured in TH/s) and a different power draw (measured in W). So, a Type A machine could be an Antminer S19. Type B could be an Antminer S19j. Type C could be an Antminer S19j Pro. And type D could be an AntminerT19, or any other SHA256 computer. Each of those would have different price points at which we would activate them for any given site for any given time and these are all SHA256 machines from one manufacturer.

In one embodiment, the system 100 could compare the cost or price of available power and other relevant operating costs to get by mining bitcoin during the period for any given machine, and select the better option. If the value of a given machine's output exceeds the price of power, then likely choose to mine bitcoin or other cryptocurrencies. If the value of a given machine's output is below the price of power, then likely choose to keep that machine turned off and instead direct that power to a better and more profitable use.

In one embodiment, the power cost and availability could be determined by accessing cost of power and working hours per day from the power plants. In one embodiment, the power cost and availability could be determined by other people, publicly available databases or real-time or daily grid power pricing from the utility or regulatory authorities or market makers, power brokers, and projection models based on past observable inputs.

In one embodiment, other variable costs associated with mining vs not-mining could be determined depending on the length of the shutdown, there may be variable costs that could be trimmed, and thus might affect the comparable calculation. In addition to the cost of power, it must consider labor required and the ability to eliminate shifts of employees during shutdowns, internet bandwidth requirements, other utility costs, and carbon offset costs (RECs).

In one embodiment, the value of mining computer hash power could be determined through the mining pool operator by offering a “bid price” for the hash power (often payable in a variety of digital currencies). In one embodiment, the value of mining computer hash power could be determined by calculating and using information about grid difficulty (via widely-available 3rd party sources or from a network node) and divide the respective computer's hash power into that difficulty to determine what share of the block rewards and transaction fees will be awarded on a probability-adjusted basis. In one embodiment, the value of mining computer hash power could be determined through available multiple 3rd-party online calculators, which can assist the miners in determining the expected production at any given time for any given hardware type.

The systems and methods of the invention in the described embodiments may be implemented as a system, method, apparatus or article of manufacture using programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may be further implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention, the systems and methods use networks, wherein, the term, ‘networks’ means a system allowing interaction between two or more electronic devices, and includes any form of inter/intra enterprise environment such as the world wide web, Local Area Network (LAN), Wide Area Network (WAN), Storage Area Network (SAN) or any form of Intranet.

In an embodiment of the invention, the systems and methods can be practiced using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, tablets, portable media players and personal digital assistants.

As noted above, the processing machine used to implement the invention may be a suitable computer or other processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system (OS). Thus, embodiments of the invention may include a processing machine running the Unix operating system, the Apple iOS operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system (such as macOS™), the Apache operating system, an OpenStep™ operating system, the Android™ operating system (and variations distributed by Samsung, HTC, Huawei, LG, Motorola, Google, Blackberry, among others), the Windows 10™ operating system, the Windows Phone operating system, the Windows 8™ operating system, Microsoft Windows™ Vista™ operating system, the Microsoft Windows™ XP™ operating system, the Microsoft Windows™ NT™ operating system, the Windows™ 2000 operating system, or another operating system or platform.

The systems and methods of the invention may utilize non-operating systems (aka serverless architecture) as well for distributed processing. In the processing of the invention, services on cloud computing networks leveraging systems like AWS (as offered by Amazon Web Services, Inc.), BlueMix (as offered by IBM), and Microsoft Azure, can perform data collection services using varying technologies that are spun up on demand using tools like Chef to create container based deployments like Docker, or non-container compute services (e.g. AWS Lambda).

The invention may use or provide real-time analytics processing that may use scale on demand to the users in the system, in accordance with at least one embodiment of the invention. Such offerings as AWS lambda and Kinesis (as offered by Amazon Web Services, Inc.) are among those that may be used in implementation of the invention. For example, AWS Lambda may be utilized to execute code (to perform processes of the invention) in response to various triggers including data changes, shifts in system state, or particular action taken by users. Similarly, in an embodiment, the OS (operating system) of the invention might be encapsulated in an EC2 instance (as offered by Amazon Web Services, Inc.) or multiple instances for deployment.

Another example of a traditional system is a device in the electrical distribution system that may speak a proprietary protocol or an older standardized protocol such as DNP3. In order to converge such a device to the modern grid it may be necessary to marshal its ‘native’ protocol into a new protocol such as IEC 61850. Further, it is often desired to do so in such a way that allows security policy to be specified and enforced independently of the application behavior, and it is also often necessary to participate more fully in field-area networks that may require localized edge processing and interaction over other protocols with other devices at the edge such that a portion of the distribution system may reasonably take some action independently of coordination through a centralized head-end. The present invention allows such systems to be realized, for example but not limited to: (1) allowing domain experts to quickly and efficiently specify application layer behavior independently of deep protocol expertise; (2) allowing multiple protocols to be bound to that application via an abstract data set, which allows different protocols to transparently interact with elements in that data set as necessary; (3) allowing a natural partitioning of application logic independently of the underlying protocols; and (4) allowing an architecture where protocol service behavior can be constrained by security policies (e.g. firewalling) independently of how an application layer will operate over that protocol.

It is appreciated that in order to practice the method of the invention as described above, it is not necessary that the processors and/or the memories of the processing machine be physically located in the same geographical location. That is, each of the processors and the memories used by the processing machine may be located in geographically distinct locations and connected so as to communicate in any suitable manner, such as over a network or over multiple networks. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the invention to communicate with any other entity; i.e., so as to obtain further instructions or to access and use remote memory stores, for example. Such communication portion, component, system, or technologies used to provide such communication might include a network, the Internet, Intranet, Extranet, LAN, an Ethernet, wireless transceiver, a radio, or any client server system that provides communication, for example. Such communications technologies may use any suitable protocol such as TCP/IP, UDP, or OSI, for example.

Further, multiple applications may be utilized to perform the various processing of the invention. Such multiple applications may be on the same network or adjacent networks, and split between non-cloud hardware, including local (on-premises) computing systems, and cloud computing resources, for example. Further, the systems and methods of the invention may use IPC (interprocess communication) style communication for module level communication. Various known IPC mechanisms may be utilized in the processing of the invention including, for example, shared memory (in which processes are provided access to the same memory block in conjunction with creating a buffer, which is shared, for the processes to communicate with each other), data records accessible by multiple processes at one time, and message passing (that allows applications to communicate using message queues), for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer, processor, or portions of the processor understands the machine language.

Any suitable programming language may be used in accordance with the various embodiments of the invention. Illustratively, the programming language used may include assembly language, Ada, APL, Basic, C, C++, C#, Objective C, COBOL, dBase, Forth, Fortran, Java, Modula-2, Node.JS, Pascal, Prolog, Python, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmission or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1. A flexible datacenter comprising:
a plurality of computing systems, wherein the plurality of computing systems are configured to receive power from at least one power source;
wherein the plurality of computing systems are in a low power sleep mode when not receiving data; and
a data control system configured to control data flow to the plurality of computing systems based at least in part on a change in economic feasibility.

2. The flexible datacenter of claim 1, wherein the change in economic feasibility comprises the cost of power to power the plurality of computing systems of the flexible datacenter.

3. The flexible datacenter of claim 1, wherein the data control system controls the transmission of data to one or more computing systems of the plurality of computing systems.

4. The flexible datacenter of claim 1, wherein the data control system controls the transmission of data to a select group of computing systems of the plurality of computing systems.

5. The flexible datacenter of claim 1, wherein the data control system is further configured to determine the change in economic feasibility.

6. The flexible datacenter of claim 5, wherein the change in economic feasibility is communicated to the data control system by an operator associated with the flexible datacenter.

7. The flexible datacenter of claim 5, wherein the change in economic feasibility is communicated to the data control system by a remote master control system.

8. The flexible datacenter of claim 1, wherein the data control system is collocated with the plurality of computing systems.

9. The flexible datacenter of claim 1, wherein the data control system is located remotely from the plurality of computing systems.

10. The flexible datacenter of claim 1, wherein the change in economic feasibility is based on the cost of power to power the plurality of computing systems of the flexible datacenter compared to the price of a crypto coin.

11. The flexible datacenter of claim 1, wherein the data control system comprises at least one primary controller and at least one lead controller.

12. The flexible datacenter of claim 1, wherein the data control system comprises at least one firewall, at least one monitoring server, and at least one switch.

13. The flexible datacenter of claim 1, wherein the data control system comprises at least one firewall, at least one monitoring server, at least one lead switch and at least one rack switch.

14. A method of controlling a flexible datacenter comprising:
receiving, by a data control system processor, a request for an application to be executed by the data control system processor, wherein the application includes a plurality of tasks including an economic feasibility analysis, a crypto mining machine analysis, and a data control schema analysis;
analyzing, by the data control system processor, the economic feasibility analysis by comparing a cost of power and the price of a crypto coin;
determining, by the data control system processor, a crypto coin processing condition has been met based on the economic feasibility analysis;
analyzing, by the data control system processor, the crypto mining machine analysis by comparing a plurality of performance capabilities of a plurality of crypto mining computing systems within the flexible datacenter to determine a set of selected crypto mining computing machines from the plurality of crypto mining computing machines which should mine crypto coin based on the economic feasibility analysis;
analyzing, by the data control system processor, the data control schema analysis by identifying a set of data flow parameters required to transmit a set of crypto mining data to be transmitted to the set of selected crypto mining machines; and
controlling at least one firewall and at least one switch using the set of data flow parameters to control the transmission of the set of crypto mining data to the set of selected crypto mining machines.

15. The method of claim 14, further comprising halting the flow of the set of crypto mining data to the set of selected crypto mining machines when the crypto coin processing condition is no longer met.

16. The method of claim 14, wherein the at least one switch comprises at least one lead switch and at least one rack switch.

17. The method of claim 14, wherein the at least one firewall comprises at least one lead firewall and at least one rack firewall.

18. The method of claim 14, further comprising a crypto mining machine device analysis comprising conducting a scan of the plurality of crypto mining devices within the flexible datacenter to determine the plurality of performance capabilities of each mining device of the a plurality of crypto mining computing systems.

19. The method of claim 18, further comprising grouping the plurality of crypto mining devices within the flexible datacenter based on the plurality of performance capabilities of each mining device.
